(19) United States
(12) Patent Application Publication
(10) Pub. No.: US 2023/0058858 A1
(43) Pub. Date: Feb. 23, 2023

(54) HEAVY DUTY PNEUMATIC TIRE

(71) Applicant: SUMITOMO RUBBER INDUSTRIES, LTD., Kobe-shi (JP)

(72) Inventor: Yasuhiro HOSODA, Kobe-shi (JP)

(73) Assignee: SUMITOMO RUBBER INDUSTRIES, LTD., Kobe-shi (JP)

(21) Appl. No.: 17/877,343

(22) Filed: Jul. 29, 2022

(30) Foreign Application Priority Data
Aug. 11, 2021 (JP) 2021-131032

(51) Int. Cl. B60C 11/01; B60C 11/13; B60C 11/11

(52) U.S. Cl. CPC B60C 11/01; B60C 11/13; B60C 11/11; B60C 2200/06; B60C 2011/0355

(57) ABSTRACT

A heavy duty pneumatic tire 2 is provided. A shoulder land portion 30s is formed on a tread 4 of the tire 2. Holes 46 are provided in the shoulder land portion 30s. Each hole 46 is provided at a position at which the hole 46 is not in contact with a normal line of an inner surface of the tire passing through an end of a tread surface 22, and a depth D of the hole 46 is not larger than a depth G of the shoulder circumferential groove 28s. The hole 46 includes an opening-side portion 92 and a hole bottom-side portion 96 connected to the opening-side portion 92 and provided radially inward of the opening-side portion 92. A width of a boundary 98 between an outer hole bottom-side portion 96A and an inner hole bottom-side portion 96B in the hole bottom-side portion 96 is 1.5 to 2.5 times a width of a radially inner end portion of the opening-side portion 92.

### TECHNICAL FIELD

The present disclosure relates to heavy duty pneumatic tires that are mounted to vehicles such as a truck and a bus.

This application claims priority on Japanese Patent Application No. 2021-131032 filed on Aug. 11, 2021, the entire content of which is incorporated herein by reference.

### BACKGROUND ART

The tread of a heavy duty pneumatic tire has a large volume. In particular, each shoulder portion thereof has a large volume, and heat is less likely to be transmitted thereto. Therefore, a vulcanization time required to form each shoulder portion of the heavy duty pneumatic tire is the rate-limiting factor for a vulcanization reaction. Therefore, it has been proposed to shorten the vulcanization time by performing vulcanization with heat conductors inserted in the shoulder portion (for example, PATENT LITERATURE 1 below).

### CITATION LIST

### Patent Literature

PATENT LITERATURE 1: Japanese Laid-Open Patent Publication No. 2020-116976.

### SUMMARY OF THE INVENTION

### Technical Problem

On the other hand, when holes into which the heat conductors are inserted are formed in the tread during production, the wear resistance and the crack resistance of the tire may be decreased.

The present disclosure has been made in view of the above circumstances, and an object of the present disclosure is to provide a heavy duty pneumatic tire in which improvement of productivity is achieved by shortening a vulcanization time while the influence on wear resistance and crack resistance is suppressed by effectively heating a tread.

### Solution to Problem

A heavy duty pneumatic tire according to an aspect of the present disclosure is a heavy duty pneumatic tire including a pair of beads, a carcass extending on and between one bead and the other bead, a belt located radially outward of the carcass, and a tread located radially outward of the belt and having a tread surface that comes into contact with a road surface, wherein: at least three circumferential grooves are formed on the tread so as to be aligned in an axial direction, whereby at least four land portions are formed therein so as to be aligned in the axial direction; among these circumferential grooves, a circumferential groove located on each outermost side in the axial direction is a shoulder circumferential groove; among these land portions, a land portion located on each outermost side in the axial direction is a shoulder land portion; holes are provided in the shoulder land portion so as to extend from an outer surface of the shoulder land portion toward an inner side in a radial direction; each hole is provided at a position at which the hole is not in contact with a normal line of an inner surface of the tire passing through an end of the tread surface; a depth of the hole is not larger than a depth of the shoulder circumferential groove; the hole includes an opening-side portion having at least one of a region whose width decreases toward the inner side in the radial direction or a region whose width is constant, and a hole bottom-side portion connected to the opening-side portion and provided radially inward of the opening-side portion; the hole bottom-side portion includes an outer hole bottom-side portion whose width increases toward the inner side in the radial direction, and an inner hole bottom-side portion whose width decreases toward the inner side in the radial direction and a width of a boundary between the outer hole bottom-side portion and the inner hole bottom-side portion is 1.5 to 2.5 times a width of a radially inner end portion of the opening-side portion.

Preferably, in the heavy duty pneumatic tire, in the hole, a shape of a cross-section perpendicular to a central axis of the hole is a circle; the width of the radially inner end portion of the opening-side portion is 2.0 to 3.5 mm; a shape of a wall surface of the inner hole bottom-side portion is a shape composed of only a part of a spherical surface; and a radius R of the spherical surface is not less than 2.0 mm.

Preferably, in the heavy duty pneumatic tire, in the hole, a shape of a cross-section perpendicular to a central axis of the hole is a circle; the width of the radially inner end portion of the opening-side portion is 2.0 to 3.5 mm; and a shape of a wall surface of the inner hole bottom-side portion is a shape composed of a combination of a curved surface and a flat surface.

Preferably, in the heavy duty pneumatic tire, a distance from a bottom to the boundary between the outer hole bottom-side portion and the inner hole bottom-side portion in the hole bottom-side portion is 25 to 50% of the width of the boundary between the outer hole bottom-side portion and the inner hole bottom-side portion.

Preferably, in the heavy duty pneumatic tire, the depth of the hole is 90 to 100% of the depth of the shoulder circumferential groove.

Preferably, in the heavy duty pneumatic tire, the depth of the hole is 12 to 25 mm.

Preferably, in the heavy duty pneumatic tire, a height of the hole bottom-side portion is 6 to 12 mm.

Preferably, in the heavy duty pneumatic tire, a interval between the holes provided in the circumferential direction is 20 to 80 mm.

Preferably, in the heavy duty pneumatic tire, a midpoint between the end of the tread surface and the tire inner surface on a normal line of the tire inner surface passing through the end of the tread surface is defined as a point PM, and a normal line of the tread surface passing through the point PM intersects the hole.

Preferably, in the heavy duty pneumatic tire, the shoulder land portion includes a plurality of shoulder blocks demarcated by a plurality of axial grooves aligned in the axial direction, an opening of the hole is located in a region where a distance from one end side in a circumferential direction in a tread surface of the shoulder block is 30 to 70% of a length in the circumferential direction of the shoulder block, and a maximum number of the holes provided in each shoulder block is three.

Preferably, in the heavy duty pneumatic tire, an opening width of the hole is larger than the width of the radially inner end portion of the opening-side portion.

Preferably, in the heavy duty pneumatic tire, a cross-sectional shape of at least a portion, of the outer hole bottom-side portion, connected to the opening-side portion is a shape haying curved lines between which a width increases toward the inner side in the radial direction.

### Advantageous Effects of the Invention

In the heavy duty pneumatic tire of the present disclosure, the tread is formed through an effective heating step. In the tire, improvement of productivity is achieved while the influence on wear resistance and crack resistance is suppressed.

### BRIEF DESCRIPTION OF DRAWINGS

FIG. 1 is a cross-sectional view showing a part of a heavy duty pneumatic tire according to an embodiment of the present disclosure.

FIG. 2 is a development showing a tread surface of the tire in FIG. 1.

FIG. 3 is an enlarged cross-sectional view showing a part of the tire in FIG. 1.

FIG. 4 illustrates a production situation of the tire in FIG. 1.

FIG. 5A is an enlarged cross-sectional view showing a hole provided in a shoulder land portion of the tire in FIG. 1.

FIG. 5B is a cross-sectional view taken along a line IV-IV in FIG. 5A.

FIG. 6 is an enlarged cross-sectional view showing a hole provided in a heavy duly pneumatic tire according to another embodiment of the present disclosure.

FIG. 7 is an enlarged cross-sectional view showing a hole provided in a shoulder land portion of a tire produced in Example 1.

FIG. 8 is an enlarged cross-sectional view showing a hole provided in a shoulder land portion of a tire produced in Example 2.

FIG. 9 is an enlarged cross-sectional view showing a hole provided in a shoulder land portion of a tire produced in Example 3.

FIG. 10 is an enlarged cross-sectional view showing a hole provided in a shoulder land portion of a tire produced in Comparative Example 2.

FIG. 11 is an enlarged cross-sectional view showing a hole provided in a shoulder land portion of a tire produced in Comparative Example 3.

FIG. 12 is an enlarged cross-sectional view showing a hole provided in a shoulder land portion of a tire produced in Comparative Example 4.

### DETAILED DESCRIPTION

The following will describe in detail the heavy duty pneumatic tire of the present disclosure based on preferred embodiments with appropriate reference to the drawings.

In the present disclosure, a state where a tire is fitted on a normal rim, the internal pressure of the tire is adjusted to a normal internal pressure, and no load is applied to the tire is referred to as a normal state. In the present disclosure, unless otherwise specified, the dimensions and angles of each component of the tire are measured in the normal state.

In the present specification, the normal rim means a rim specified in a standard on which the tire is based. The “standard rim” in the JATMA standard, the “Design Rim” in the TRA standard, and the “Measuring Rim” in the ETRTO standard are normal rims.

In the present specification, the normal internal pressure means an internal pressure specified in the standard on which the tire is based. The “highest air pressure” in the JATMA standard, the “maximum value” recited in “TIRE LOAD LIMITS AT VARIOUS COLD INFLATION PRESSURES” in the TRA standard, and the “INFLATION PRESSURE” in the ETRTO standard are normal internal pressures.

In the present specification, the normal load means a load specified in the standard on which the tire is based. The “maximum load capacity” in the JATMA standard, the “maximum value” recited in “TIRE LOAD LIMITS AT VARIOUS COLD INFLATION PRESSURES” in the TRA standard, and the “LOAD CAPACITY” in the ETRTO standard are normal loads.

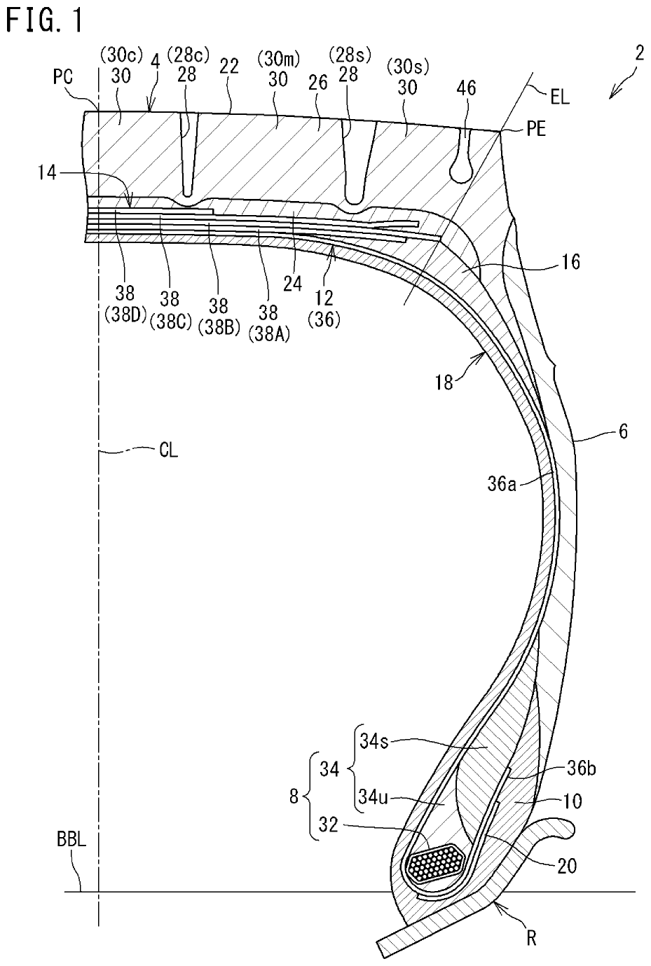

FIG. 1 shows a part of a heavy duty pneumatic tire 2 (hereinafter, sometimes referred to simply as “tire 2”) according to an embodiment of the present disclosure. The tire 2 is mounted to a heavy duty vehicle such as a truck and a bus, for example.

FIG. 1 shows a part of a cross-section along a plane including the rotation axis of the tire 2. In FIG. 1, the right-left direction is the axial direction of the tire 2, and the up-down direction is the radial direction of the tire 2. The direction perpendicular to the surface of the drawing sheet of FIG. 1 is the circumferential direction of the tire 2. In FIG. 1, an alternate long and short dash line CL represents the equator plane of the tire 2. In FIG. 1, the tire 2 is fitted on a rim R (normal rim).

In FIG. 1, a solid line BBL extending in the axial direction is a bead base line. This bead base line is a line that defines the rim diameter (see JATMA or the like) of the rim R.

The tire 2 includes a tread 4, a pair of sidewalls 6, a pair of beads 8, a pair of chafers 10, a carcass 12, a belt 14. a pair of cushion layers 16, an inner liner 18, and a pair of steel reinforcing lavers 20.

The tread 4 comes into contact with a road surface at an outer surface 22 thereof, that is, at a tread surface 22 thereof. Reference sign PC represents the point of intersection of the tread surface 22 and the equator plane CL. The point of intersection PC corresponds to the equator of the tire 2.

The tread 4 includes a base portion 24 and a cap portion 26 located radially outward of the base portion 24. The base portion 24 is formed from a crosslinked rubber that has low heat generation properties and for which adhesiveness is taken into consideration. The cap portion 26 is formed from a crosslinked rubber for which wear resistance and grip performance are taken into consideration. The cap portion 26 covers the entirety of the base portion 24.

In the tire 2, at least three circumferential grooves 28 are turned on the tread 4. Accordingly, at least four land portions 30 are formed in the tread 4. In the tire 2, at least four circumferential grooves 28 may be formed on the tread 4, and accordingly at least five land portions 30 may be formed in the tread 4. In the tire 2 shown in FIG. 1, four circumferential grooves 28 are formed on the tread 4, and five land portions 30 are formed in the tread 4.

Each sidewall 6 is connected to an end of the tread 4. The sidewall 6 extends radially inward from the end of the tread 4. The sidewall 6 is formed from a crosslinked rubber.

Each bead 8 is located radially inward of the sidewall 6. The bead 8 includes a core 32 and an apex 34.

The core 32 extends in the circumferential direction. The core 32 includes a wound wire made of steel.

The apex 34 is located radially outward of the core 32. The apex 34 extends radially outward from the core 32. The apex 34 includes an inner apex 34u and an outer apex 34s. The inner apex 34u and the outer apex 34s are each formed from a crosslinked rubber. The outer apex 34s is more flexible than the inner apex 34u.

Each chafer 10 is located axially outward of the bead 8. The chafer 10 is located radially inward of the sidewall 6. The chafer 10 comes into contact with the rim R. The chafer 10 is formed from a crosslinked rubber.

The carcass 12 is located inward of the tread 4, each sidewall 6, and each chafer 10. The carcass 12 extends on and between one bead 8 and the other bead 8. The carcass 12 includes at least one carcass ply 36. The carcass 12 of the tire 2 is composed of one carcass ply 36.

In the tire 2, the carcass ply 36 is turned up around each bead 8 from the inner side toward the outer side in the axial direction. The carcass ply 36 has a ply body 36a which extends from one bead 8 toward the other bead 8, and a pair of turned-up portions 36b which are connected to the ply body 36a and turned up around the respective cores 32 from the inner side toward the outer side in the axial direction.

The carcass ply 36 includes a large number of carcass cords aligned with each other, which are not shown. The carcass cords are covered with a topping rubber. Each carcass cord intersects the equator plane CL. In the tire 2, an angle of each carcass cord with respect to the equator plane CL is not less than 70° and not greater than 90°. The carcass 12 has a radial structure. In the tire 2, the material of the carcass cords is steel. A cord formed from an organic fiber may be used as each carcass cord.

The belt 14 is located radially inward of the tread 4. The belt 14 is located radially outward of the carcass 12.

The belt 14 includes a plurality of layers 38 stacked in the radial direction. The belt 14 of the tire 2 includes four layers 38. in the tire 2, the number of layers 38 included in the belt 14 is not particularly limited. The configuration of the belt 14 is determined as appropriate in consideration of the specifications of the tire 2.

Each layer 38 includes a large number of belt cords aligned with each other, which are not shown. The belt cords are covered with a topping rubber. The material of the belt cords is steel. The belt cords of the tire 2 are steel cords.

Although not shown, the belt cords are tilted relative to the equator plane CL. In the tire 2, the belt 14 is formed such that the belt cords of one layer 38 intersect the belt cords of another layer 38 stacked on the one layer 38.

In the tire 2, among the four layers 38, a second layer 38B located between a first layer 38A and a third layer 38C has the largest width in the axial direction. A fourth layer 38D located on the outermost side in the radial direction has the smallest width in the axial direction.

Each cushion layer 16 is located between the belt 14 and the carcass 12 at a portion of the belt 14 at an end thereof, that is, at an end portion of the belt 14. The cushion layer 16 is formed from a crosslinked rubber.

The inner liner 18 is located inward of the carcass 12. The inner liner 18 forms an inner surface of the tire 2. The inner liner 18 is formed from a crosslinked rubber that has an excellent air blocking property. The inner liner 18 maintains the internal pressure of the tire 2.

Each steel reinforcing layer 20 is located at a bead 8 portion. In the axial direction, the steel reinforcing layer 20 is located outward of the bead 8. The steel reinforcing layer 20 is located between the carcass ply 36 and the chafer 10. The inner end of the steel reinforcing layer 20 is located radially inward of the core 32. The outer end of the steel reinforcing layer 20 is located between an end of the turned-up portion 36b and the core 32 in the radial direction.

The steel reinforcing layer 20 includes a large number of filler cords aligned with each other, which are not shown. In the steel reinforcing layer 20, the filler cords are covered with a topping rubber. The material of the filler cords is steel.

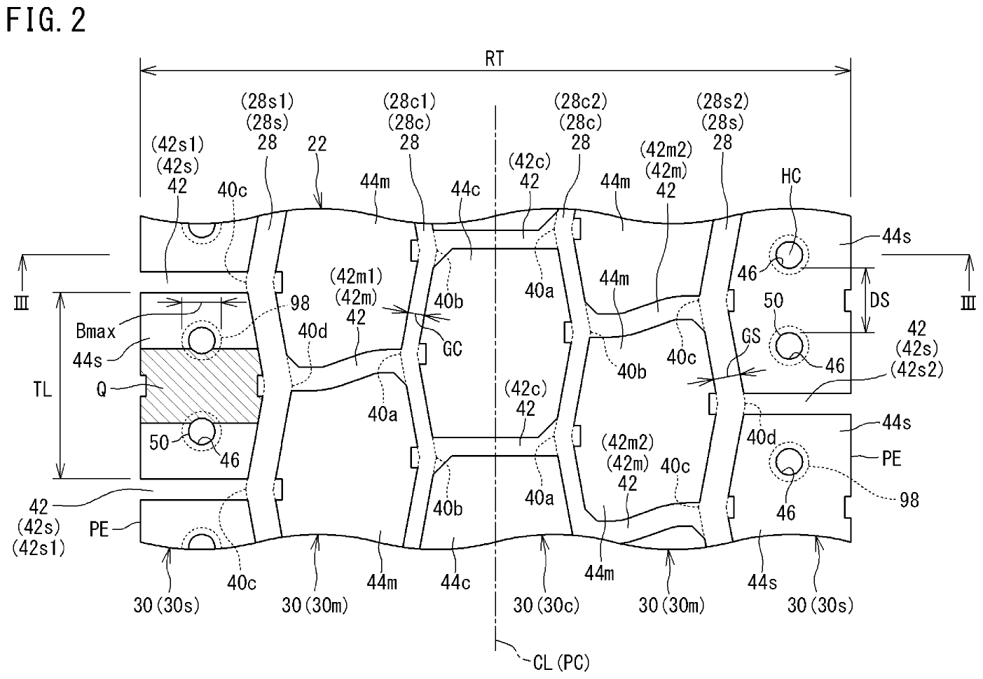

FIG. 2 shows a development of the tread surface 22. In FIG. 2, the right-left direction is the axial direction of the tire 2, and the up-down direction is the circumferential direction of the tire 2. The direction perpendicular to the surface of the drawing sheet of FIG. 2 is the radial direction of the tire 2.

In FIG. 1 and FIG. 2, reference sign PE represents each end of the tread surface 22. In the tire 2, when the ends PE of the tread surface 22 cannot be identified from the appearance, the outer ends in the axial direction of a ground-contact surface obtained when the normal load is applied to the tire 2 in the normal state and the tread 4 is brought into contact with a flat surface at a camber angle of 0° are defined as the ends PE of the tread surface 22.

As described above, in the tire 2, the four circumferential grooves 28 are formed on the tread 4. These circumferential grooves 28 are aligned in the axial direction and continuously extend in the circumferential direction.

Among the four circumferential grooves 28, circumferential grooves 28c located on the inner side in the axial direction, that is, circumferential grooves 28c near an equator PC, are center circumferential grooves. Circumferential grooves 28s located on the outermost sides in the axial direction, that is, circumferential grooves 28s near the ends PE of the tread surface 22, are shoulder circumferential grooves. In the case where the circumferential grooves 28 formed on the tread 4 include a circumferential groove 28 located on the equator PC, the circumferential groove 28 located on the equator PC is a center circumferential groove. Furthermore, in the case where a circumferential groove 28 is present between the center circumferential groove 28c and the shoulder circumferential groove 28s, this circumferential groove 28 is a middle circumferential groove.

Each center circumferential groove 28c continuously extends in the circumferential direction in a zigzag manner. The center circumferential groove 28c has zigzag peaks 40a which project on one side in the axial direction, and zigzag peaks 40b which project on the other side in the axial direction. In the center circumferential groove 28c, the zigzag peaks 40a and the zigzag peaks 40b are alternately arranged in the circumferential direction. In the tire 2, the center circumferential groove 28c may be formed as a groove extending straight in the circumferential direction.

Each shoulder circumferential groove 28s continuously extends in the circumferential direction in a zigzag manner. The shoulder circumferential groove 28s has zigzag peaks 40c which project on one side in the axial direction, and zigzag peaks 40d which project on the other side in the axial direction. In the shoulder circumferential groove 28s, the zigzag peaks 40c and the zigzag peaks 40d are alternately arranged in the circumferential direction. In the tire 2, the shoulder circumferential groove 28s may be formed as a groove extending straight in the circumferential direction.

As shown in FIG. 2, in the tire 2, the zigzag peaks 40b of the center circumferential groove 28c located on the left side of the drawing sheet (hereinafter, also referred to as first center circumferential groove 28c1) and the zigzag peaks 40a of the center circumferential groove 28c located on the right side of the drawing sheet (hereinafter, also referred to as second center circumferential groove 28c2) are bridged by axial grooves 42c (hereinafter, also referred to as center axial grooves 42c).

As shown in FIG. 2, in the tire 2, the zigzag peaks 40d of the shoulder circumferential groove 28s located on the left side of the drawing sheet (hereinafter, also referred to as first shoulder circumferential groove 28s1) and the zigzag peaks 40a of the first center circumferential groove 28c1 are bridged by axial grooves 42m (hereinafter, also referred to as first middle axial grooves 42m1). The first shoulder circumferential groove 28s1 communicates at the zigzag peaks 40c thereof with axial grooves 42s (hereinafter, also referred to as first shoulder axial grooves 42s1) extending inward from the end PE of the tread surface 22.

As shown in FIG. 2, in the tire 2, the zigzag peaks 40c of the shoulder circumferential groove 28s located on the right side of the drawing sheet (hereinafter, also referred to as second shoulder circumferential groove 28s2) and the zigzag peaks 40b of the second center circumferential groove 28c2 are bridged by axial grooves 42m (hereinafter, also referred to as second middle axial grooves 42m2). The second shoulder circumferential groove 28s2 communicates at the zigzag peaks 40d thereof with axial grooves 42s (hereinafter, also referred to as second shoulder axial grooves 42s2) extending inward from the end PE of the tread. surface 22.

In FIG. 2, a double-headed arrow RT indicates the actual width of the tread surface 22. The actual width RT is represented by the distance from one end PE of the tread surface 22 to the other end PE of the tread surface 22. The actual width RT is measured along the tread surface 22.

In FIG. 2, a double-headed arrow GC indicates the actual width of the center circumferential groove 28c. A double-headed arrow GS indicates the actual width of the shoulder circumferential groove 28s. The actual width GC is represented by the shortest distance from one edge of the center circumferential groove 28c to the other edge of the center circumferential groove 28c. The actual width GS is represented by the shortest distance from one edge of the shoulder circumferential groove 28s to the other edge of the shoulder circumferential groove 28s.

In the tire 2, from the viewpoint of contribution to drainage performance and traction performance, the actual width GC of the center circumferential groove 28c is preferably 1 to 10% of the actual width RT of the tread surface 22. The depth of the center circumferential groove 28c is preferably 13 to 25 mm.

In the tire 2, from the viewpoint of contribution to drainage performance and traction performance, the actual width GS of the shoulder circumferential groove 28s is preferably 1 to 10% of the actual width RT of the tread surface 22. The depth of the shoulder circumferential groove 28s is preferably 13 to 25 mm.

In the tire 2, the actual width GS of the shoulder circumferential groove 28s is larger than the actual width GC of the center circumferential groove 28c. The actual width GS of the shoulder circumferential groove 28s may be smaller than the actual width GC of the center circumferential groove 28c, or the actual width GS of the shoulder circumferential groove 28s may be equal to the actual width GC of the center circumferential groove 28c. The actual widths of the circumferential grooves 28 are determined as appropriate according to the specifications of the tire 2.

In the tire 2, the depth of the shoulder circumferential groove 28s is equal to the depth of the center circumferential groove 28c. The shoulder circumferential groove 28s may deeper than the center circumferential groove 28c, or the shoulder circumferential groove 28s may be shallower than the center circumferential groove 28c. The depths of the circumferential grooves 28 are determined as appropriate, according to the specifications of the tire 2.

In the tire 2, the actual width of each axial groove 42 is set as appropriate in a range of 1 to 10% of the actual width RT of the tread surface 22. The depth of the axial groove 42 is set as appropriate in a range of 13 to 25 mm.

In the tire 2, the actual width of the axial groove 42 may be equal to the actual width of the circumferential groove 28, the actual width of the axial groove 42 may be smaller than the actual width of the circumferential groove 28, or the actual width of the axial groove 42 may be larger than the actual width of the circumferential groove 28. The actual width of the axial groove 42 is determined as appropriate according to the specifications of the tire 2.

In the tire 2, the depth of the axial groove 42 may be equal to the depth of the circumferential groove 28, the depth of the axial groove 42 may be larger than that of the circumferential groove 28, or the depth of the axial groove 42 may be smaller than that of the circumferential groove 28. The depth of the axial groove 42 is determined as appropriate according to the specifications of the tire 2.

As described above, in the tire 2, the four circumferential grooves 28 are formed on the tread 4, whereby the five land portions 30 are formed in the tread 4. These land portions 30 are aligned in the axial direction and extend in the circumferential direction.

Among the five land portions 30, a land portion 30c located on the inner side in the axial direction, that is, a land portion 30c located on the equator PC, is a center land portion. Land portions 30s located on the outermost sides in the axial direction, that is, land portions 30s including the ends PE of the tread surface 22, are shoulder land portions. Furthermore, land portions 30m located between the center land portion 30c and the shoulder land portions 30s are middle land portions. In the case where the land portion 30 located on the inner side in the axial direction, among the land portions 30 formed in the tread 4, is located not on the equator PC but near the equator PC, the land portion 30 located near the equator PC, that is, the land portion 30 located on the equator PC side, is a center land portion.

On the center land portion 30c, a large number of the above-described center axial grooves 42c are formed. Accordingly, a large number of center blocks 44c are formed so as to be arranged at a predetermined pitch in the circumferential direction. The center land portion 30c of the tire 2 includes the large number of center blocks 44c arranged at a predetermined pitch in the circumferential direction. The center land portion 30c may be composed of a projection portion that is continuous in the circumferential direction. In this case, the above-described center axial grooves 42c are not formed on the center land portion 30c.

On each middle land portion 30m, a large number of the above-described middle axial grooves 42m are formed. Accordingly, a large number of middle blocks 44m are formed so as to be arranged at a predetermined pitch in the circumferential direction. The middle land portion 30m of the tire 2 includes the large number of middle blocks 44m arranged at a predetermined pitch in the circumferential direction. The middle land portion 30m may be composed of a projection portion that is continuous in the circumferential direction. In this case, the above-described middle axial grooves 42m are not formed on the middle land portion 30m.

On each shoulder land portion 30s, a large number of the above-described shoulder axial grooves 42s are formed. Accordingly, a large number of shoulder blocks 44s are formed so as to be arranged at a predetermined pitch in the circumferential direction. The shoulder land portion 30s of the tire 2 includes the large number of shoulder blocks 44s arranged at a predetermined pitch in the circumferential direction. The shoulder land portion 30s may be composed of a projection portion that is continuous in the circumferential direction. In this case, the above-described shoulder axial grooves 42s are not formed on the shoulder land portion 30s.

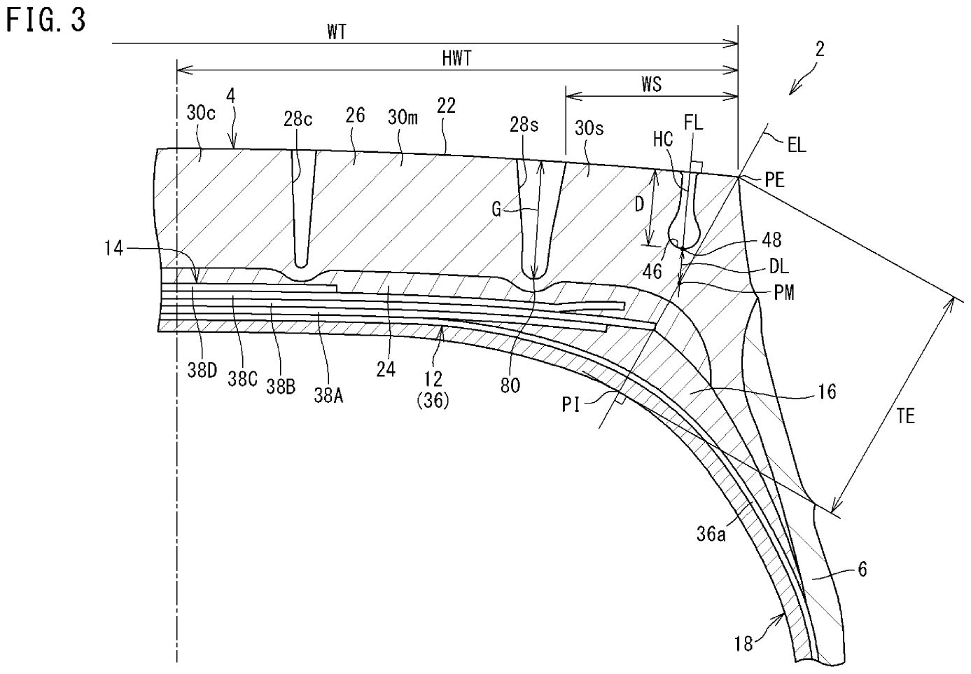

FIG. 3 shows a cross-section of the tire 2 along a line III-III in FIG. 2. The cross-section of the tire 2 shown in FIG. 3 is a part of the cross-section of the tire 2 shown in FIG. 1. In FIG. 3, the right-left direction is the axial direction of the tire 2, and the up-down direction is the radial direction of the tire 2. The direction perpendicular to the surface of the drawing sheet of FIG. 3 is the circumferential direction of the tire 2.

In the present disclosure, the thickness of the tire 2 is measured along a normal line of the inner surface of the tire 2 (specifically, the inner surface of the inner liner 18) in the cross-section of the tire 2 shown in FIG. 1 or FIG. 3.

In FIG. 1 and FIG. 3, a solid line EL is the normal line of the inner surface of the tire 2 (specifically, the inner surface of the inner liner 18) passing through the end PE of the tread surface 22. A double-headed arrow TE indicates the thickness of the tire 2 measured along the normal line EL of the inner surface of the tire 2.

The tire 2 has the maximum thickness TE at the position of the normal line EL. In other words, the thickness of the tire 2 measured along the normal line of the inner surface of the tire 2 shows the maximum at the normal line EL of the inner surface of the tire 2 passing through the end PE of the tread surface 22. As shown in FIG. 3, the normal line EL traverses a portion of the tire 2 at the shoulder land portion 30s. In the tire 2, the portion at the shoulder land portion 30s has the maximum thickness TE.

In the tire 2, holes 46 are provided in each shoulder land portion 30s. As shown in FIG. 1 to FIG. 3, each hole 46 extends from the outer surface of the shoulder land portion 30s, specifically, the outer surface of the shoulder block 44s, which forms a part of the tread surface 22, toward the inner side in the radial direction. In FIG. 2, the line III-III is a straight line passing through the center of the hole 46 and extending in the axial direction.

As shown in FIG. 3, the hole 46 is provided at a position at which the hole 46 is not in contact with the normal line EL of the inner surface of the tire 2 passing through the end PE of the tread surface 22 (including the case where the normal line EL does not traverse the hole 46). That is, the hole 46 is located radially outward of the normal line EL. In this case, a bottom 48 of the hole 46 can ensure a sufficient distance to the belt 14. Therefore, cracks starting from the bottom 48 or an end portion of the belt 14 are less likely to occur than in the case where the distance between the bottom 48 of the hole 46 and the belt 14 is short.

Moreover, the hole 46 is provided at the position at which the hole 46 is not in contact with the normal line EL. Therefore, the hole 46 is not excessively close to the end PE of the tread surface 22, and a sufficient distance to the end PE of the tread surface 22 therefrom is ensured. If the hole 46 is excessively close to the end PE of the tread surface 22, damage is likely to occur at the hole 46. However, by providing a hole at the above-described position, damage that occurs due to the hole 46 being excessively close to the end PE can be avoided.

In FIG. 3, a double-headed arrow D indicates the depth of the hole 46, and a double-headed arrow G indicates the depth of the shoulder circumferential groove 28s. In the tire 2, the depth D of the hole 46 is not larger than a depth G of the shoulder circumferential groove 28s. In other words, the depth D of the hole 46 is equal to the depth G of the shoulder circumferential groove 28s, or smaller than the depth G. If the depth D of the hole 46 is larger than the depth G of the shoulder circumferential groove 28s, the distance between the bottom 48 of the hole 46 and the belt 14 is short, so that there is a concern that cracks starting from the bottom 48 of the hole 46 or cracks starting from the end portion of the belt 14 are likely to occur.

The depth D of the hole 46 is preferably 90 to 100% of the depth G of the shoulder circumferential groove 28s. When the depth D of the hole 46 is set in such a range, the vulcanization time (heating time) when producing the tire 2 is shortened, and efficient production of the tire 2 is achieved. In addition, since a sufficient distance between the bottom 48 of the hole 46 and the belt 14 is ensured, occurrence of cracks starting from the bottom 48 of the hole 46 or damage at the end portion of the belt 14 is suppressed, and good wear resistance is also ensured.

The depth D of the hole 46 is preferably set in a range of 12 to 25 mm.

In FIG. 3, the double-headed arrow D indicates the depth of the hole 46. The depth D of the hole 46 is represented by the distance from the tread surface 22 to the bottom 48 of the hole 46. The double-headed arrow G indicates the depth of the shoulder circumferential groove 28s. The depth of the shoulder circumferential groove 28s is represented by the distance from the tread surface 22 to a bottom 80 of the shoulder circumferential groove 28s.

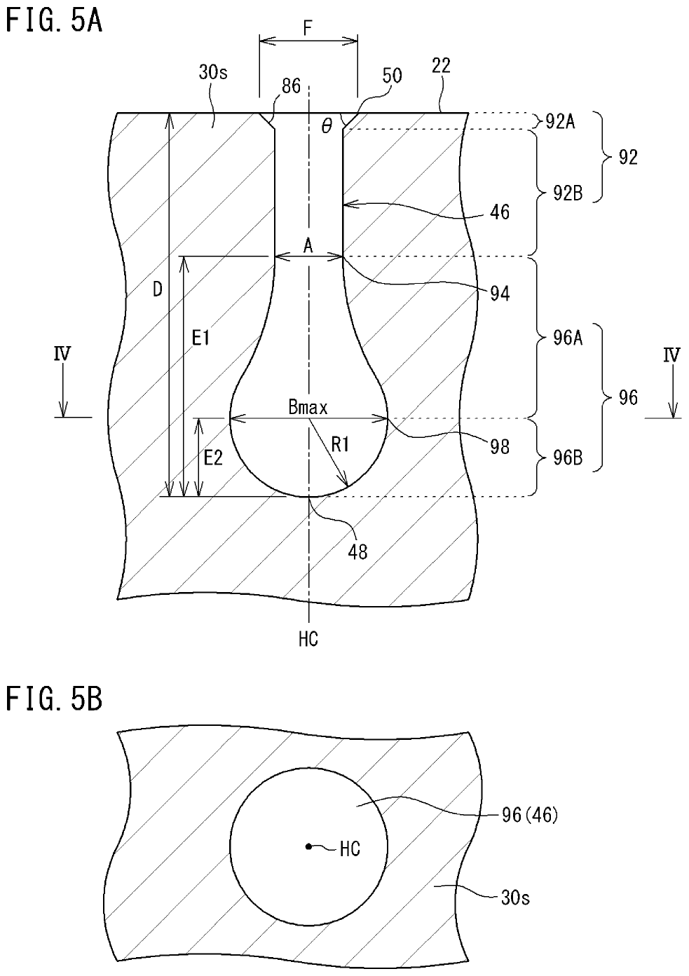

As shown in FIG. 3 and FIG. 5A, the hole 46 includes an opening-side portion 92 and a hole bottom-side portion 96 which are provided in order from the tread surface 22 side toward the inner side in the radial direction, and the hole bottom-side portion 96 is connected to the opening-side portion 92. The opening-side portion 92 has a region 92A (hereinafter, also referred to as tapered portion 92A) whose width decreases toward the inner side in the radial direction, and a region 92B (hereinafter, also referred to as constant-width portion 92B) whose width is constant toy and the inner side in the radial direction. The hole bottom-side portion 96 has an outer hole bottom-side portion 96A whose width increases toward the inner side in the radial direction, and an inner hole bottom-side portion 96B whose width decreases toward the inner side in the radial direction.

FIG. 5B is a cross-sectional view taken along a line IV-IV in FIG. 5A.

FIG. 5A shows a cross-sectional view of the hole 46 along a plane including the rotation axis of the tire 2. The shape of a cross-section perpendicular to a central axis HC of the hole 46 is a circle as shown in FIG. 5B. Therefore, the overall shape of the hole 46 is a shape obtained by rotating the cross-sectional shape in FIG. 5A about the central axis HC of the hole 46. The shape of the hole 46 is a shape like a round-bottom flask.

In the tire of the embodiment of the present disclosure, the central axis HC of the hole coincides with a straight line connecting the center of gravity of the shape of the opening of the hole on the tread surface and the bottom of the hole (if the bottom of the hole is flat, the center of gravity of the flat shape of the bottom).

In the tire 2 of the present disclosure, the width of the hole refers to the length of a longest portion in the shape of the cross-section perpendicular to the central axis HC of the hole. Therefore, in the hole 46, since the shape of the cross-section perpendicular to the central axis HC of the hole 46 is a circle, the diameter of the circle is the width of the hole at the cross-section position.

In the hole bottom-side portion 96 of the hole 46, a boundary 98 between the outer hole bottom-side portion 96A and the inner hole bottom-side portion 96B is a portion having a maximum width Bmax in the hole bottom-side portion 96.

In the hole 46, the maximum width Bmax of the hole bottom-side portion 96 is set to 1.5 to 2.5 times a width A of a radially inner end portion 94 of the opening-side portion 92.

In the hole 46, the width A of the radially inner end portion 94 of the opening-side portion 92 is preferably set to 2.0 to 3.5 mm. More preferably, the range of the width A is 2.5 to 3.0 mm.

If the width A is less than 2.0 mm, the effect of shortening the vulcanization time (heating time) when producing the tire 2 becomes poor. On the other hand, if the width A exceeds 3.5 mm, the stiffness of each shoulder block in the tire 2 may become lower, so that the wear resistance of the shoulder block may be poor.

In the tire 2 in which the holes 46 having such a shape are provided, a portion corresponding to each shoulder land portion which has a large volume and to which heat is less likely to be transmitted can be efficiently heated when a green tire is vulcanized during production. In addition, in the hole 46, the width of the hole bottom-side portion 96 is larger than the width of the opening-side portion 92. Therefore, even though the depth of the hole is not so large compared to the case where a hole having a constant width along the radial direction is provided, a portion corresponding to each shoulder land portion of the green tire can be efficiently heated.

The tire 2 is produced as follows. In the production of the tire 2, first, an uncrosslinked tire, that is, a green tire 2r, is prepared by combining members such as the tread 4 and the sidewalls 6 on a shaping machine (not shown).

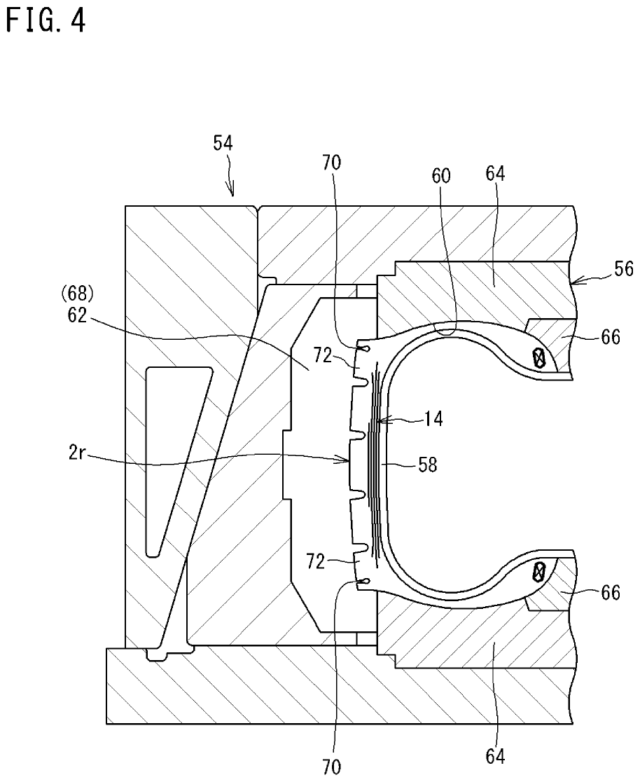

In the production of the tire 2, the green tire 2r is vulcanized and molded in a vulcanizer 54 shown in FIG. 4. The vulcanizer 54 includes a mold 56 and a bladder 58.

The mold 56 has a cavity face 60 on the inner surface thereof. The cavity face 60 comes into contact with the outer surface of the green tire 2r and shapes the outer surface of the tire 2.

The mold 56 shown in FIG. 4 is a segmented mold. The mold 56 includes a tread ring 62, a pair of side plates 64, and a pair of bead rings 66 as components. In the mold 56, the above-described cavity face 60 is formed by combining these components. The mold 56 in FIG. 4 is in a state where these components are combined, that is, in a closed state.

In the mold 56, the tread ring 62 forms the tread 4 portion of the tire 2. The tread ring 62 is composed of a large number of segments 68. Each side plate 64 forms the sidewall 6 portion of the tire 2, and each bead ring 66 forms the bead 8 portion of the tire 2.

When producing the tire 2, the number of segments 68 included in the tread ring 62 is not particularly limited, and may be selected as appropriate in consideration of the demoldability of the tire 2 after molding.

At the segments 68, projections 70 having a shape corresponding to the shape of the hole 46 are provided at predetermined positions. The projections 70 are formed from a thermally conductive material. Therefore, in the vulcanization step, heat is supplied to portions, of the green tire 2r, corresponding to the shoulder land portions 30s, and these portions are efficiently heated.

The bladder 58 is located inside the mold 56. The bladder 58 is formed from a crosslinked rubber. The inside of the bladder 58 is filled with a heating medium such as steam. Accordingly, the bladder 58 expands. The bladder 58 shown in FIG. 4 is in a state where the bladder 58 is filled with the heating medium to be expanded. The bladder 58 comes into contact with the inner surface of the green tire 2r and shapes the inner surface of the tire 2. In the production of the tire 2, a rigid core made of metal may be used instead of the bladder 58. The rigid core has a toroidal outer surface. This outer surface is approximated to the shape of the inner surface of the tire 2 in a state where the tire 2 is filled with air and the internal pressure of the tire 2 is maintained at 5% of the normal internal pressure.

In the production of the tire 2, the green tire 2r is placed into the mold 56 that is set at a predetermined temperature. Thereafter, the mold 56 is closed. The bladder 58 expanded by the filling with the heating medium presses the green tire 2r against the cavity face 60 from the inside. The green tire 2r is pressurized and heated inside the mold 56 for a predetermined time. Accordingly, the rubber composition of the green tire 2r is cross-linked to obtain the tire 2.

As is obvious from FIG. 1, the tread 4 portion of the tire 2 has a larger volume than the volume of the sidewall 6 portion. As described above, in the tire 2, in the tread 4 portion, the portion at the shoulder land portion 30s has the maximum thickness TE. That is, in the tire 2, the portion at the shoulder land portion 30s has a particularly large volume.

In the production of the tire 2, heat is transmitted to the green tire 2r by the mold 56 and the bladder 58. In the green tire 2r, a portion having a small volume and a portion having a large volume coexist. Heat is easily transmitted to the portion having a small volume, but heat is not easily transmitted to the portion having a large volume.

If a time for pressurizing and heating the green tire 2r, that is, a vulcanization time, are set based on the portion to which heat is easily transmitted, there is a concern that the progress of vulcanization may be insufficient in the portion to which heat is not easily transmitted. On the other hand, if a vulcanization time is set based on the portion to which heat is not easily transmitted, there is a concern that the vulcanization may excessively proceed in the portion to which heat is easily transmitted. Then, there is a concern that the excessively vulcanized portion may have an increased loss tangent (tan δ), resulting in inferior wear resistance.

There is also a method in which the vulcanization temperature is set to be lower than usual in order to suppress excessive progress of vulcanization. However, in this case, the vulcanization time needs to be set longer, so that there is a concern that the productivity of the tire may decrease.

As described above, in the tire 2, the holes 46 having a predetermined shape are provided in each shoulder land portion 30s. Therefore, as shown in FIG. 4, the projections 70 are provided to the mold 56 of the tire 2 in order to form the holes 46. Among the components of the mold 56, the segments 68 form the tread 4 portion of the tire 2. Therefore, the projections 70 are provided at portions, of the segments 68, which form the shoulder land portion 30s.

In the production of the tire 2, when the green tire 2r is pressurized and heated inside the mold 56, the above-described projections 70 are inserted into portions, of the green tire 2r, corresponding to the shoulder land portions 30s (hereinafter, shoulder land portion-corresponding portions 72). Accordingly, each shoulder land portion-corresponding portion 72 is also heated from the inside thereof. Therefore, the time for the shoulder land portion-corresponding portion 72 to reach an optimum vulcanization state is shortened.

Each projection 70 has a shape corresponding to the hole 46 of the tire 2. That is, the projection 70 is designed such that the width on the distal end side is larger than the width on the proximal side. Therefore, in the production of the tire 2, the inside of each shoulder land portion-corresponding portion 72 is efficiently heated.

The production of the tire 2 can shorten the vulcanization time. The tire 2 contributes to improvement of productivity.

In the tire 2, from the viewpoint of improving the productivity, as shown in FIG. 3, the midpoint between the end PE and a tire inner surface PI on a normal line EL of the tire inner surface passing through the end PE of the tread surface 22 is denoted by PM, and the hole 46 is preferably provided so as to intersect a normal line FL of the tread surface 22 passing through the point PM.

A region around the midpoint PM on the normal line EL is a region to which heat is least likely to be transmitted when a green tire is heated by using a mold having no projection 70. Therefore, when the tire 2 is produced by using a mold in which the projections 70 for forming the holes 46 are provided at the above-described positions, it is possible to produce the tire 2 with high productivity without impairing the wear resistance and the crack resistance of the produced tire 2.

In the tire 2, particularly preferably, each hole 46 is provided at a position at which the central axis HC of the hole 46 overlaps the normal line FL of the tread surface 22 passing through the point PM.

In FIG. 3, a double-leaded arrow DL indicates the distance between the bottom 48 of the hole 46 and the point PM.

In the tire 2, preferably, each hole 46 is provided such that the distance between the bottom (hole deepest portion) 48 of the hole 46 and the point PM is small while satisfying a condition that the hole 46 is not in contact with the normal line EL of the tire inner surface passing through the end PE of the tread surface 22.

In the tire 2, improvement of productivity is achieved while the influence on wear resistance and crack resistance is suppressed.

In each hole 46 provided in the tire 2, the shape of the cross-section perpendicular to the central axis of the hole 46 is a circle as described above, and the hole 46 has a shape like a round-bottom flask. The shape of the wall surface of the inner hole bottom-side portion 96B in the hole 46 is the surface of a hemisphere. In other words, the shape of the wall surface of the inner hole bottom-side portion 96B is a shape composed of a part (half) of a spherical surface.

Since the shape of the wall surface of the inner hole bottom-side portion 96B is such a shape, good demoldability after vulcanization can be ensured during production of the tire 2. In addition, in the produced tire 2, cracks starting from the wall surface of the inner hole bottom-side portion 96B are less likely to occur.

The shape of the wall surface of the inner hole bottom-side portion 96B of the hole 46 provided in the tire 2 is not limited to such a shape. Another shape will be described later.

In the hole 46 provided in the tire 2, the wall surface of the outer hole bottom-side portion 96A is composed of a smooth curved surface whose width continuously increases toward the inner side in the radial direction. Therefore, good demoldability after vulcanization can be ensured.

From the viewpoint of ensuring good demoldability after vulcanization, in the tire 2, the cross-sectional shape of at least a portion, of the outer hole bottom-side portion 96A, connected to the opening-side portion 92 (the shape of a cross-section along a plane including the rotation axis of the tire 2; see FIG. 5A) is preferably a shape having curved lines between which the width increases toward the inner side in the radial direction.

In the hole bottom-side portion 96 of the hole 46 provided in the tire 2, the shape of the wall surface of the inner hole bottom-side portion 96B is a hemisphere. Thus, in the hole bottom-side portion 96, a distance E2 from the bottom 48 of the hole 46 to the boundary 98 between the outer hole bottom-side portion 96A and the inner hole bottom-side portion 96B is 50% of the width of the boundary 98 between the outer hole bottom-side portion 96A and the inner hole bottom-side portion 96B. In other words, the distance E2 from the bottom 48 of the hole 46 to the boundary 98 between the outer hole bottom-side portion 96A and the inner hole bottom-side portion 96B is 50% of the maximum width Bmax of the hole bottom-side portion 96.

In the tire 2, the distance E2 from the bottom 48 of the hole 46 to the position of the maximum width Bmax of the hole bottom-side portion 96 (the position of the boundary 98 between the outer hole bottom-side portion 96A and the inner hole bottom-side portion 96B) is preferably set to 25 to 50% of the maximum width Bmax of the hole bottom-side portion 96. When the position of the maximum width Bmax of the hole bottom-side portion 96 is set to such a position, the position indicating the maximum width Bmax of the hole bottom-side portion 96 is near the midpoint PM between the end PE and the tire inner surface PI, and is therefore more suitable for efficiently heating the shoulder land portion-corresponding portion 72 of the green tire 2r when producing the tire 2 having holes each having such a shape.

On the other hand, if the distance E2 from the bottom 48 of the hole 46 to the position of the maximum width Bmax of the hole bottom-side portion 96 exceeds 50% of the maximum width Bmax of the hole bottom-side portion 96, the position of the maximum width Bmax of the hole bottom-side portion 96 is distant from the midpoint PM between the end PE of the tread surface 22 and the tire inner surface PI, which is disadvantageous from the viewpoint of efficient heating. In addition, if the distance E2 from the bottom 48 of the hole 46 to the position of the maximum width Bmax of the hole bottom-side portion 96 is less than 25% of the maximum width Bmax of the hole bottom-side portion 96, it is difficult to make the shape of the wall surface of the inner hole bottom-side portion 96B into a shape with Which the demoldability after vulcanization is good and crack resistance is ensured.

In the hole 46 of the tire 2, a height E1 of the hole bottom-side portion 96 is preferably set to 6 to 12 mm.

This case is suitable for achieving improvement of productivity while the influence on wear resistance is suppressed.

In the hole 46 shown in FIG. 5A, a radius R1 of the spherical surface forming the wall surface of the inner hole bottom-side portion 96B included in the hole bottom-side portion 96 is preferably not less than 2 mm. Accordingly, good crack resistance can be ensured. In addition, the upper limit of the radius R2 is preferably 4 mm from the viewpoint of ensuring good crack resistance.

FIG. 5A shows a part of the cross-section of the tire 2 shown in FIG. 3. FIG. 5A shows the hole 46 provided in the shoulder land portion 30s. In FIG. 5A, a double-headed arrow F indicates the width of an opening 50 of the hole 46 (hereinafter, also referred to as opening width F).

The opening width F of the hole 46, the width A of the radially inner end portion 94 of the opening-side portion 92, and the maximum width Bmax of the hole bottom-side portion 96 are all specified in the cross-section shown in FIG. 5A, that is, in the cross-section of the tire 2 along a plane including the rotation axis of the tire 2 and the central axis HC of the hole 46.

In the tire 2, the shape of the cross-section perpendicular to the central axis HC of the hole 46 is a circle. In the production of the tire 2, the shape of the cross-section of the hole 46 may be any of various shapes such as an ellipse and a rectangle as long as the projection 70 can be pulled out from the tire 2. From the viewpoint that the projection 70 is easily pulled out from the tire 2 during production of the tire 2 and the obtained tire 2 has good crack resistance, the shape of the cross-section of the hole 46 is preferably a circle or an ellipse, and particularly preferably a circle. In the case where the shape of the cross-section of the hole 46 is an ellipse, the central axis HC of the hole 46 passes through the point of intersection of the major and minor axes of this ellipse.

As described above, the hole 46 of the tire 2 shown in FIG. 5A and FIG. 5B has the tapered portion 92A at the radially outer portion of the opening-side portion 92. In other words, the portion at the opening 50 is formed so as to have a tapered shape.

In the tire 2, the tapered portion at the opening 50 suppresses movement of the tread surface 22 surrounding the opening 50. The tapered portion at the opening 50 (tapered portion 92A) suppresses occurrence of uneven wear.

Moreover, the tire 2 having the hole 46 having the tapered portion 92A also has excellent demoldability after vulcanization.

In FIG. 5A, in the tapered portion 92A of the hole 46, an angle θ is an angle of a wall surface 86 of the tapered portion 92A with respect to a virtual tread surface obtained on the assumption that the hole 46 is not provided (hereinafter, sometimes referred to as tilt angle of the wall surface 86 of the tapered portion 92A).

In the tire 2, the tilt angle θ of the wall surface 86 of the tapered portion 92A is preferably not greater than 80°. Accordingly, movement of the tread surface 22 surrounding the opening 50 is effectively suppressed. In the tire 2, occurrence of uneven wear is effectively suppressed. From this viewpoint, the angle θ is more preferably not greater than 70° and further preferably not greater than 60°. From the same viewpoint, the angle θ is preferably not less than 20°, more preferably not less than 30°, and further preferably not less than 40°.

As shown in FIG. 2, a plurality of the holes 46 are provided in each shoulder land portion 30s. These holes 46 are arranged at intervals in the circumferential direction. In FIG. 2, a double-headed arrow DS indicates the interval between one hole 46 and another hole 46 located adjacent to the one hole 46 in the circumferential direction. The interval DS is measured along the tread surface 22.

In the tire 2, the interval DS between the holes 46 provided in the circumferential direction is preferably not less than 20 mm and preferably not greater than 80 mm. When the interval DS is set to be not less than 20 mm, the stiffness of the shoulder land portion 30s is appropriately maintained. From this viewpoint, the interval DS is more preferably not less than 30 mm. When the interval DS is set to be not greater than 80 mm, each shoulder land portion-corresponding portion 72 is effectively heated from the inside thereof by the projections 70, which are provided to the mold 56 in order to form the holes 46, in the production of the tire 2. In the production of the tire 2, the time for the shoulder land portion-corresponding portion 72 to reach an optimum vulcanization state is effectively shortened. From this viewpoint, the interval DS is more preferably not greater than 70 mm.

As shown in FIG. 2, two holes 46 are provided in each shoulder block 44s included in the shoulder land portion 30s. The number of holes 46 provided in each shoulder block 44s is determined as appropriate in consideration of the stiffness of the shoulder block 44s and the vulcanization time of the tire 2. The number of holes 46 provided in each shoulder block 44s is preferably set to a maximum of three. If many holes 46 are provided, there is a concern that the stiffness of the shoulder block 44s may decrease or the design properties of the tire 2 may deteriorate.

The number of holes 46 is preferably two or three.

In FIG. 2, reference sign Q indicates a region where the distance from one end side in the circumferential direction in the tread surface 22 of the shoulder block 44s is 30 to 70% of a length TL in the circumferential direction of the shoulder block 44s.

In the tire 2, in the case where a hole 46 is provided in the shoulder land portion 30s, the hole 46 is preferably located at a position in the region Q. In this case, a situation in which the position at which the hole 46 is provided is excessively close to the shoulder axial groove 42s provided on the shoulder land portion 30s, is avoided. Therefore, a concern that the stiffness of the shoulder block 44s may decrease or uneven wear may occur in the tread surface 22 of the shoulder block 44s due to the position, at which the hole 46 is provided, being excessively close to the shoulder axial groove 42s, is avoided.

Here, the hole 46 being located in the region Q refers to a state where, in the tread surface 22 of the shoulder block 44s, a part or the entirety of the opening 50 of the hole 46 overlaps the region Q in the radial direction.

In FIG. 3, a double-headed arrow WS indicates the width in the axial direction of the shoulder land portion 30s. The width WS in the axial direction is represented by the distance in the axial direction from the inner end to the outer end (that is, the end PE of the tread surface 22) of the outer surface of the shoulder land portion 30s.

In the tire 2, the ratio of the width WS in the axial direction of the shoulder land portion 30s to a half HWT of a width WT in the axial direction of the tread 4 is preferably not less than 0.30 and preferably not greater than 0.55. In this case, in the tire 2, wear is further less likely to occur on the shoulder land portion 30s. In this case, in the tire 2, occurrence of uneven wear (for example, uneven wear in which the entirety of the shoulder land portion 30s is worn) is further suppressed.

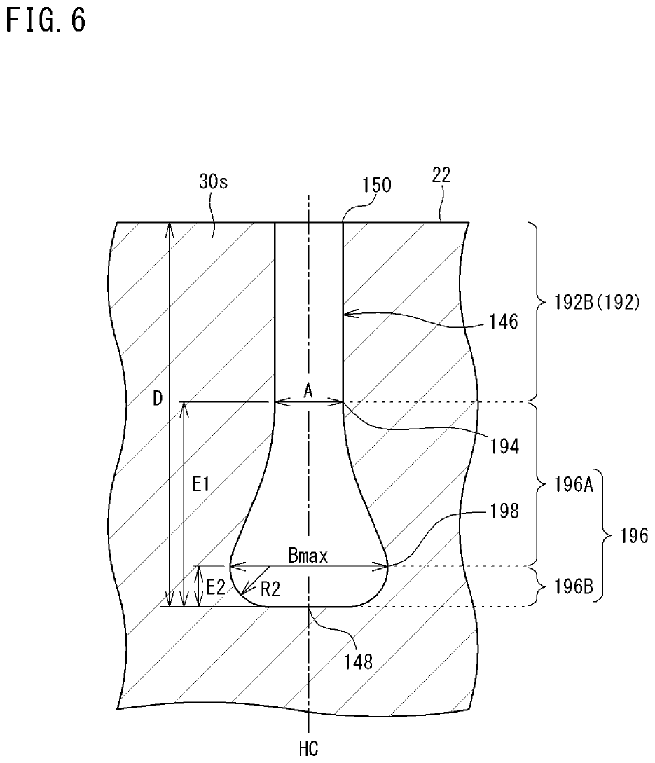

In the embodiment of the present disclosure, as described above, the shape of each hole provided in the tire 2 is not limited to a shape like the hole 46. The hole provided in the tire 2 may have a shape like a hole 146 shown in FIG. 6.

FIG. 6 is an enlarged cross-sectional view showing a hole provided in a heavy duty pneumatic tire according to another embodiment of the present disclosure.

As shown in FIG. 6, the hole 146 includes an opening-side portion 192 and a hole bottom-side portion 196 which are provided in order from the tread surface 22 side of the shoulder land portion 30s toward the inner side in the radial direction. The hole bottom-side portion 196 is connected to the opening-side portion 192. The opening-side portion 192 has a region 192B (hereinafter, also referred to as a constant-width portion 192B) whose width is constant toward the inner side in the radial direction. The hole bottom-side portion 196 has an outer hole bottom-side portion 196A whose width increases toward the inner side in the radial direction, and an inner hole bottom-side portion 196B whose width decreases toward the inner side in the radial direction.

Unlike the hole 46, the hole 146 shown in FIG. 6 does not include a tapered portion having a wall surface having a tapered shape, at a portion at an opening 150 thereof. In the tire 2 according to the embodiment of the present disclosure, the shape of the hole may be a shape having no tapered portion as described above.

FIG. 6 shows a cross-sectional view of the hole 146 along a plane including the rotation axis of the tire 2. The shape of a cross-section perpendicular to a central axis HC of the hole 146 is a circle, and the overall shape of the hole 46 is a shape obtained by rotating the cross- sectional shape in FIG. 6 about the central axis HC of the hole 146. The shape of the hole 146 is a shape like an Erten never flask in which a portion connecting a side surface to a bottom surface is rounded.

In the hole bottom-side portion 1% of the hole 146, a boundary 198 between the outer hole bottom-side portion 196A and the inner hole bottom-side portion 196B is a portion having a maximum width Bmax in the hole bottom-side portion 196. In the hole 146, the maximum width Bmax of the hole bottom-side portion 196 is set to 1.5 to 2.5 times a width A of a radially inner end portion 194 of the opening-side portion 192.

In the tire in which the holes 146 having such a shape are provided, a portion corresponding to each shoulder land portion 30s which has a large volume and to which heat is less likely to be transmitted can be efficiently heated when a green tire is vulcanized during production. In addition, since the width of the hole bottom-side portion 196 is larger than the width of the opening-side portion 192, even though the depth of the hole is not so large compared to the case where a hole having a constant width along the radial direction is provided, a portion corresponding to each shoulder land portion of the green tire can be efficiently heated.

In the hole 146, the width A of the radially inner end portion 194 of the opening-side portion 192 is preferably set to 2.0 to 3.5 mm. More preferably, similar to the hole 46 shown in FIG. 5A and FIG. 5B, the range of the width A is 2.5 to 3.0 mm.

If the width A is less than 2.0 mm, the effect of shortening the vulcanization time (heating time) becomes poor. If the width A exceeds 3.5 mm, the stiffness of each shoulder block in the produced tire may become lower, so that the wear resistance of the shoulder block may be poor.

In the hole 146, the shape of the cross-section perpendicular to the central axis of the hole 146 is a circle as described above, and the hole 146 has a shape like an Erlenmeyer flask. The shape of the wall surface of the inner hole bottom-side portion 196B in the hole 146 is a shape obtained by combining a curved surface and a flat surface. In other words, the shape of the inner hole bottom-side portion 196B is a shape drawn by rotating an outline, of the inner hole bottom-side portion 196B, which includes two arcs connected to the outer hole bottom-side portion 196A and having a radius R2 and a line segment connecting the two arcs shown in FIG. 6, about the central axis HC of the hole 146.

In the case where the shape of the wall surface of the inner hole bottom-side portion 196B is such a shape as well, the green tire 2r can be efficiently heated while the influence on the wear resistance and the crack resistance of the produced tire is suppressed.

In the hole 146, the wall surface of the outer hole bottom-side portion 196A has a tapered shape in which the width increases toward the inner side in the radial direction. Here, the shape of a cross-section of the outer hole bottom-side portion 196A (the shape of a cross-section along a plane including the rotation axis of the tire 2) is a shape in which a portion connected to the opening-side portion 192 is composed of curved lines between which the width increases toward the inner side in the radial direction, as shown in FIG. 6, and a portion radially inward of this curved line portion is composed of straight lines between which the width increases toward the inner side in the radial direction and curved lines connected to the inner hole bottom-side portion 196B.

Even in the case where a mold used during production has projections 70 each having a shape corresponding to the hole 146 having such a shape, a green tire can be successfully demolded from the mold without any damage or the like after the green tire is vulcanized.

In the hole bottom-side portion 196 of the hole 146, a distance E2 from a bottom 148 of the hole 146 to the boundary 198 between the outer hole bottom-side portion 196A and the inner hole bottom-side portion 196B is 25% of the width of the boundary 198 between the outer hole bottom-side portion 196A and the inner hole bottom-side portion 196B (the maximum width Bmax of the hole bottom-side portion 196).

The distance E2 is preferably 25 to 50% of the width of the boundary 198 between the outer hole bottom-side portion 196A and the inner hole bottom-side portion 196B (the maximum width Bmax of the hole bottom-side portion 196), and the reason for this is as described above.

In the hole 146 of the tire 2, a height E1 of the hole bottom-side portion 196 is preferably set to 6 to 12 mm.

This case is suitable for achieving improvement of productivity while the influence on wear resistance is suppressed.

As described above, each hole provided in the tire according to the embodiment of the present disclosure may be the hole 146 haying a shape as shown in FIG. 6.

Furthermore, the hole 146 having a shape as shown in FIG. 6 may include a tapered portion at the portion at the opening 150 (radially outer portion of the opening-side portion) thereof.

In the hole 146 shown in FIG. 6, the curved surface forming the wall surface of the inner hole bottom-side portion 196B included in the hole bottom-side portion 196 is a curved surface drawn by rotating the arcs having the radius R2 about the central axis HC as described above. Here, from the viewpoint of ensuring good crack resistance, the radius R2 is preferably not less than 1 mm and not greater than 3 mm.

Each of the above two arcs is, for example, a quarter arc.

In each of the holes 46 and 146 shown in FIG. 5A and FIG. 5B and in FIG. 6, the opening-side portion may be composed of a combination of a tapered portion and a constant-width portion as in the hole 46, or may be composed of only a constant-width portion as in the hole 146.

Furthermore, the opening-side portion may be formed in only a tapered shape in which the width decreases toward the inner side in the radial direction. In this case, the opening width of the hole is preferably smaller than the maximum width of the hole bottom-side portion.

Furthermore, in the embodiment of the present disclosure, the shape of the wall surface of the inner hole bottom-side portion in the hole bottom-side portion of the hole is not limited to a part, of a spherical surface or a combination of a curved surface and a flat surface, and may be composed of a combination of a part of a spherical surface and a flat surface, only a curved surface, only a flat surface, or the like.

Moreover, in the embodiment of the present disclosure, it is sufficient that the width of the outer hole bottom-side portion increases toward the inner side in the radial direction, and the width of the inner hole bottom-side portion decreases toward the inner side in the radial direction. Therefore, the width of the outer hole bottom-side portion does not necessarily increase continuously, and may increase intermittently. In addition, the width of the inner hole bottom-side portion does not necessarily decrease continuously, and may decrease intermittently.

As is obvious from the above description, in the tire 2, improvement of productivity is achieved while the influence on wear resistance and crack resistance is suppressed.

The present disclosure exhibits a more remarkable effect particularly in the tire 2 in which the thickness TE, of the portion at the shoulder land portion 30s, measured along the normal line EL of the inner surface of the tire 2 passing through the end PE of the tread surface 22 is set to be not less than 35 mm.

The embodiments disclosed above are merely illustrative in all aspects and are not restrictive. The technical scope of the present disclosure is not limited to the above-described embodiments, and all changes which come within the range of equivalency of the configurations recited in the claims are therefore intended to be included therein.

### EXAMPLES

The following will describe the present disclosure in further detail by means of examples, etc., but the present disclosure is not limited to these examples.

### Example 1

A heavy duty pneumatic tire (tire size=275/80R22.5) having the basic structure shown in FIG. 1 and having specifications shown in Table 1 below was obtained.

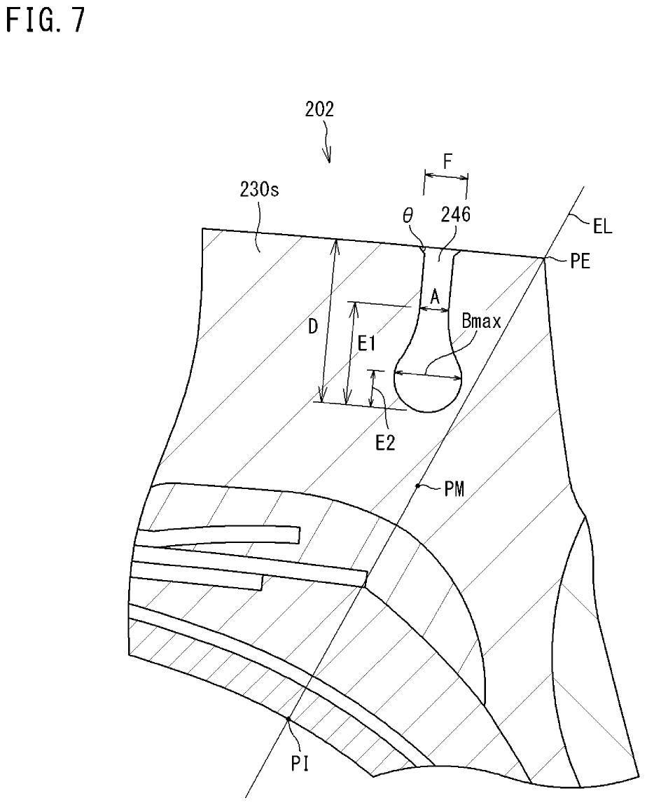

In Example 1, a tire 202 in which holes 246 having a shape shown in FIG. 7 were provided in each shoulder land portion 230s was produced.

In Example 1, the number of holes 246 provided in each shoulder block (hereinafter, hole number) was two. In each of the holes 246, the width A of the radially inner end portion of the opening-side portion was 2.5 mm, the maximum width Bmax of the hole bottom-side portion was 6 mm, the opening width F of the hole 246 was 3.5 mm, and the tilt angle θ of the wall surface of the tapered portion was 50°. In addition, the depth D of the hole was 15 mm, and the height E1 of the hole bottom-side portion was 9 mm.

The shape of the wall surface of the inner hole bottom-side portion of the hole 246 was a hemisphere (see FIG. 5A; the radius R1 of the hemisphere was 3 mm), and the distance E2 from the bottom of the hole 246 to the position indicating the maximum width Bmax of the hole bottom-side portion was 50% of the maximum width Bmax of the hole bottom-side portion. The depth G of the shoulder circumferential groove was 16 mm.

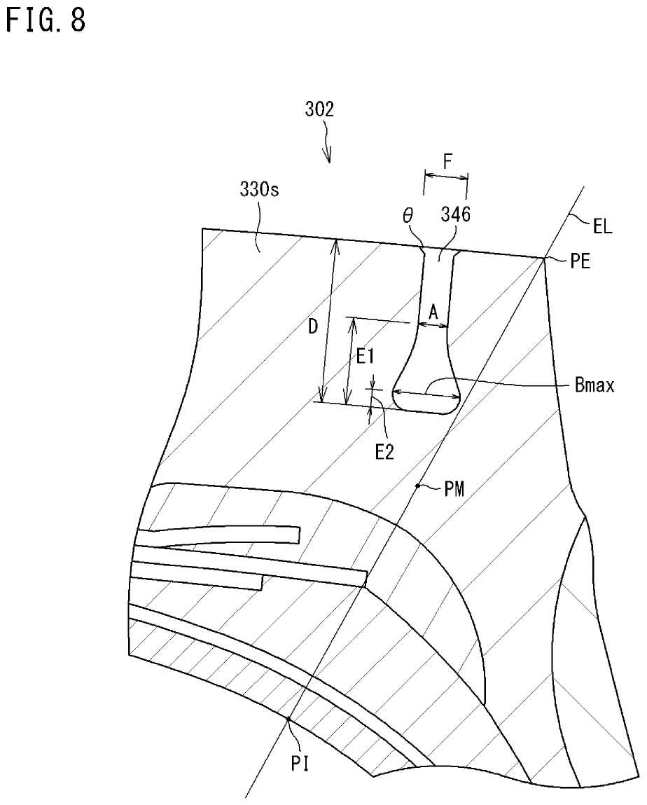

In Example 1, the thickness of the tire measured along the normal line EL of the tire inner surface passing through the end PE of the tread surface was 50 mm. In FIG. 7, PM indicates the midpoint between the end PE of the tread surface and the tire inner surface PI (hereinafter, the same applies to FIG. 8 to FIG. 12).

### Example 2

A tire 302 in which holes 346 having a shape shown in FIG. 8 were provided in each shoulder land portion 330s was obtained.

The tire 302 of Example 2 is the same as the tire of Example 1 except that the shapes of the holes 346 are different from the shapes of the holes 246 of the tire of Example 1.

In each of the holes 346 of the tire 302 of Example 2, the width A of the radially inner end portion of the opening-side portion was 2.5 mm, the maximum width Bmax of the hole bottom-side portion was 6 mm, the opening width F of the hole 346 was 3.5 mm, and the tilt angle θ of the wall surface of the tapered portion was 50°. In addition, the depth D of the hole was 15 mm, and the height E1 of the hole bottom-side portion was 10.5 mm.

The shape of the wall surface of the inner hole bottom-side portion of the hole 346 was a shape obtained by combining a curved surface and a flat surface (see FIG. 6; the radius R2 of the arc of the outline in the cross-sectional view was 1.5 mm), and the distance E2 from the bottom of the hole 346 to the position indicating the maximum width Bmax of the hole bottom-side portion was 25% of the maximum width Bmax of the hole bottom-side portion. The depth G of the shoulder circumferential groove was 16 mm.

### Example 3

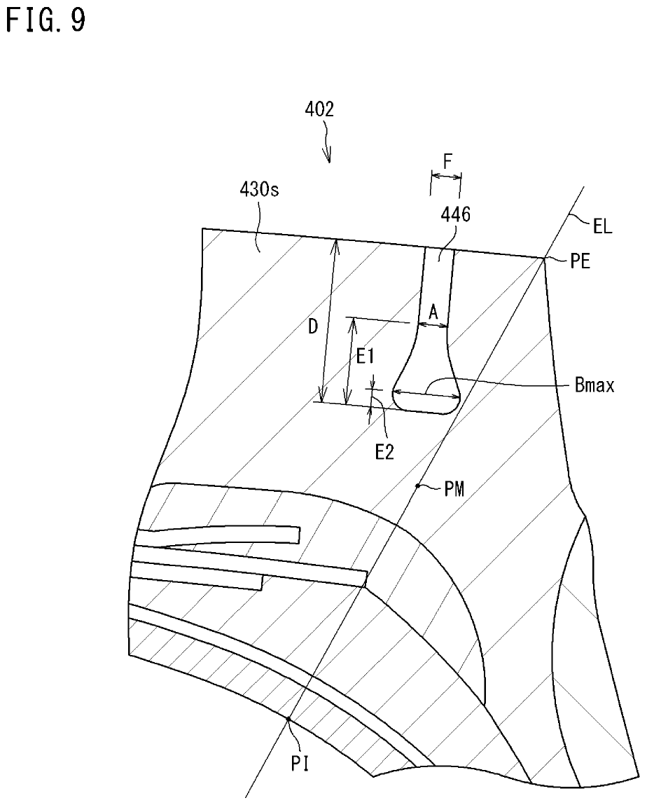

A tire 402 in which holes 446 having a shape shown in FIG. 9 were provided in each shoulder land portion 430s was obtained.

The tire 402 of Example 3 is the same as the tire of Example 2 except that the shapes of the holes 446 are different from those of the holes 346 of the tire of Example 2.

The holes 446 of the tire 402 of Example 3 have the same configuration as the holes 346 of the fire 302 of Example 2 except that no tapered portion was provided in the opening-side portion the entire opening-side portion was composed of a constant-width portion.

### Comparative Example 1

A tire of Comparative Example 1 is a conventional tire. No hole was provided in each shoulder land portion of Comparative Example 1. The configuration of this tire is the same as that of the tire 202 of Example 1 except that no hole was provided.

### Comparative Example 2

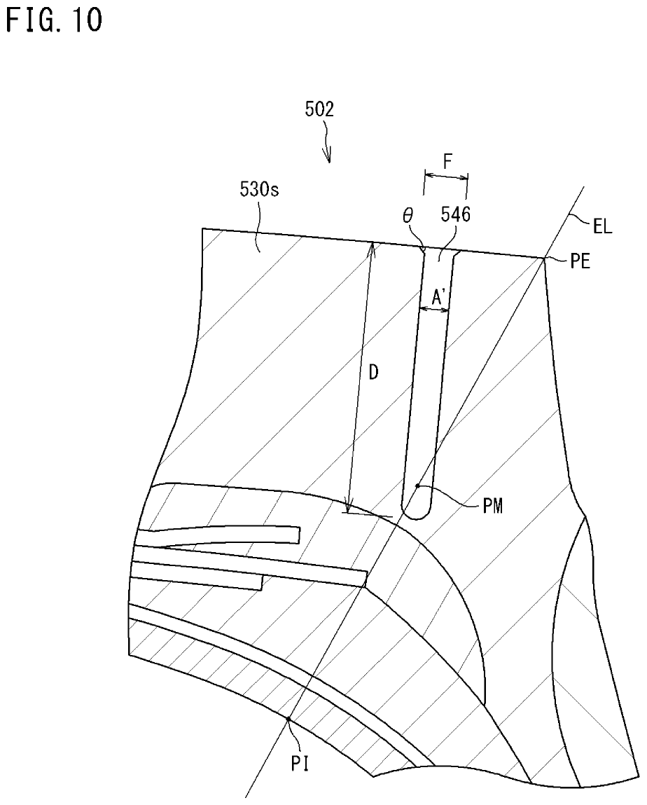

A tire 502 in which holes 546 having a shape shown in FIG. 10 were provided in each shoulder land portion 530s was obtained.

The tire 502 of Comparative Example 2 is the same as the tire of Example 1 except that the shapes of the holes 546 are different from the shapes of the holes 246 of the tire of Example 1.

Each of the holes 546 of the fire 502 of Comparative Example 2 had a tapered portion at an end portion on the opening side, a portion radially inward of the tapered portion had a cylindrical shape in which the width was constant toward the bottom, and the shape of the bottom surface was a hemispherical shape.

The width (diameter of the cylindrical portion) A′ of the hole 546 was 2.5 mm, the opening width F of the hole 546 was 3.5 mm, and the tilt angle θ of the wall surface of the tapered portion was 50°. In addition, the depth D of the hole was 25 mm.

### Comparative Example 3

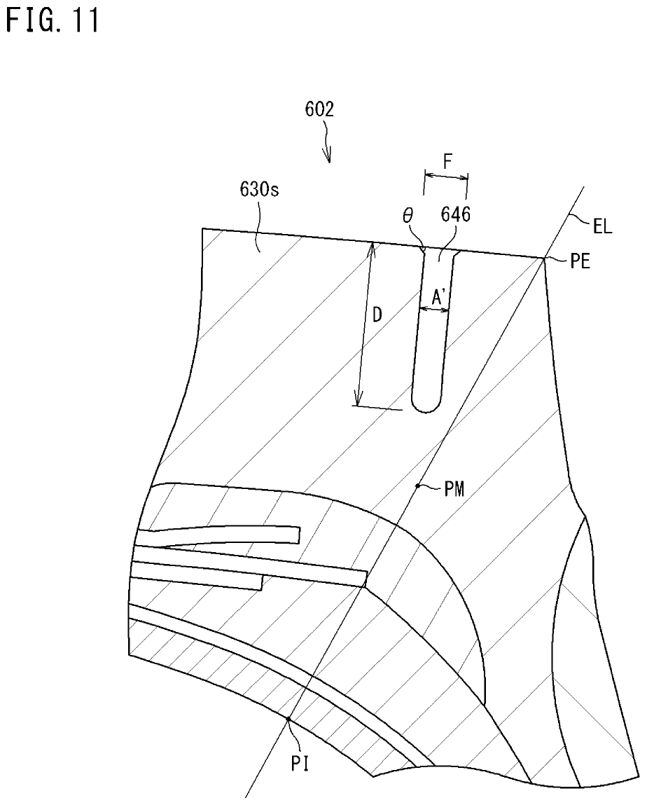

A tire 602 in which holes 646 having a shape shown in FIG. 11 were provided in each shoulder land portion 630s was obtained.

The tire 602 of Comparative Example 3 is the same as the tire of Comparative Example 2 except that the shapes of the holes 646 are different from those of the holes 546 of the tire of Comparative Example 2.

The holes 646 of the tire 602 of Comparative Example 3 have the same configuration as the holes 546 of the tire 502 of Comparative Example 2 except that the depth D of each hole was 15 mm.

### Comparative Example 4

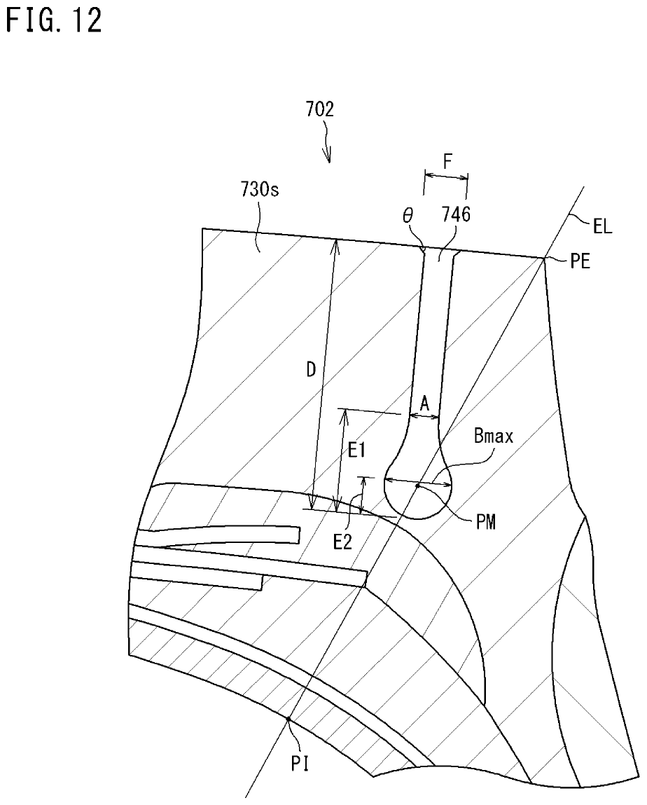

A tire 702 in which holes 746 having a shape shown in FIG. 12 were provided in each shoulder land portion 730s was obtained.

The tire 702 of Comparative Example 4 is the same as the tire of Example 1 except that the shapes of the holes 746 are different from those of the holes 246 of the tire of Example 1.

The holes 746 of the tire 702 of Comparative Example 4 have the same configuration as the holes 246 of the tire 202 of Example 1 except that the depth D of each hole was 25 mm.

<Evaluation>[Vulcanization Shortening Performance]

When the tires were produced in the Examples and the Comparative Examples, a green tire 2r was vulcanized with a thermocouple inserted into an unvulcanized rubber portion near the midpoint PM of the end PE and the tire inner surface PI on the normal line EL of the tire inner surface passing through the end PE of the tread surface, and change of the internal temperature of each tire during vulcanization was measured and compared.

Here, the time until the internal temperature of the tire rose to a predetermined temperature was measured. The results are shown in Table 1 below as relative values with the result of Comparative Example 1 being regarded as 100. A higher value means that the vulcanization time is shorter and the productivity is better.

[Uneven Wear Resistance]

Apart from the above evaluation of vulcanization shortening performance, tires were produced without inserting a thermocouple therein. A test tire was fitted onto a rim (size=8.25×22.5) and inflated with air to adjust the internal pressure of the tire to 750 kPa. The tire was mounted to the first drive shaft of a trailer head. A load applied to the tire was 60% of a load index (light load state). The trailer head was caused to run for 50,000 km on general roads, and a step amount at the hole after running was measured as the amount of wear. The results are shown in Table 1 below as relative values with the result of Comparative Example 3 being regarded as 100. The higher the value, the less likely uneven wear occurs and the better the wear resistance.

[Crack Resistance]

For each test tire produced without inserting a thermocouple therein, the amount of strain applied to the bottom of the hole provided in the shoulder land portion was calculated by simulation using the finite element method (FEM), and the obtained amounts of strain were compared. The results are shown in Table 1 below as relative values with the result of Comparative Example 3 being regarded as 100. The higher the value, the smaller the amount of strain and the better the crack resistance

TABLE 1

| | | | | | Comp. | Comp. | Comp. | Comp. |
|---|---|---|---|---|---|---|---|---|
| | | Ex. 1 | Ex. 2 | Ex. 3 | Ex. 1 | Ex. 2 | Ex. 3 | Ex. 4 |
| Configuration | Hole shape (reference figure) | FIG. 7 | FIG. 8 | FIG. 9 | None | FIG. 10 | FIG. 11 | FIG. 12 |
| of hole | Depth D of hole (mm) | 15 | ← | ← | — | 25 | 15 | 25 |
| | Depth G of shoulder | 16 | ← | ← | 16 | ← | ← | ← |
| | circumferential groove (mm) | | | | | | | |
| | Width A of radially inner | 2.5 | ← | ← | — | — | — | 2.5 |
| | end portion of opening-side | | | | | | | |
| | portion (mm) | | | | | | | |
| | Width A′ of hole (mm) | — | — | — | — | 2.5 | 2.5 | — |
| | Maximum width Bmax of hole | 6 | ← | ← | — | — | — | 6 |
| | bottom-side portion (mm) | | | | | | | |
| | Height E1 of hole bottom-side | 9 | 10.5 | ← | — | — | — | 9 |
| | portion (mm) | | | | | | | |
| | Presence/absence of tapered | Presence | Presence | Absence | — | Presence | Presence | Presence |
| | region in opening-side portion | | | | | | | |
| | Opening width F of hole (mm) | 3.5 | ← | 2.5 | — | 3.5 | ← | ← |
| | Tilt angle θ of wall surface | 50 | ← | — | — | 50 | ← | ← |
| | in tapered region (°) | | | | | | | |
| | Configuration of wall | Hemispherical | Curved | ← | — | — | — | Hemispherical |
| | surface of inner hole | surface | surface + flat | | | | | surface |
| | bottom-side portion | | surface | | | | | |
| | Radius R of spherical surface | 3 | — | — | — | — | — | 3 |
| | forming wall surface of inner | | | | | | | |
| | hole bottom-side portion (mm) | | | | | | | |
| | Ratio of distance E2 from | 50 | 25 | ← | — | — | — | 50 |
| | bottom to position indicating | | | | | | | |
| | maximum width of hole bottom- | | | | | | | |
| | side portion, to maximum width | | | | | | | |
| | of hole bottom-side portion (%) | | | | | | | |
| Performance | Vulcanization shortening | 150 | 155 | 155 | 100 | 150 | 120 | 160 |
| | performance | | | | | | | |
| | Crack resistance | 110 | 105 | 105 | — | 30 | 100 | 70 |
| | Uneven wear resistance | 100 | 100 | 95 | — | 90 | 100 | 80 |

As shown in Table 1, it is confirmed that in the Examples, improvement of productivity is achieved while the influence on wear resistance and crack resistance is suppressed. The Examples have better evaluations than the Comparative Examples. From the evaluation results, advantages of the present disclosure are clear.

### INDUSTRIAL APPLICABILITY

The above-described technology for achieving improvement of productivity while the influence on wear resistance and crack resistance is suppressed can be applied to various tires.

### REFERENCE SIGNS LIST

2 tire

2r green tire

4 tread

6 sidewall

8 head

12 carcass

14 belt

18 inner liner

22 outer surface (tread surface) of tread 4

24 base portion

26 cap portion

28, 28c, 28c1, 28c2, 28s, 28s1, 28s2 circumferential groove

30, 30c, 30s, 30m land portion

36 carcass ply

36a ply body

36b turned-up portion

38, 38A, 38B, 38C, 38D layer of belt 14

46, 146, 246, 346, 446, 546, 646, 746 hole

48, 148 bottom of hole

50, 150 opening of hole

54 vulcanizer

56 mold

58 bladder

60 cavity face

62 tread ring

68 segment

70 projection

72 shoulder land portion-corresponding portion

86 wall surface of tapered portion 92A

92, 192 opening-side portion

92A tapered portion

92B, 192B constant-width portion

94, 194 radially inner end portion of opening-side portion

96, 196 hole bottom-side portion

96A, 196A outer hole bottom-side portion

96B, 196B inner hole bottom-side portion

98, 198 boundary between outer hole bottom-side portion and inner hole bottom-side portion

1. A heavy duty pneumatic tire comprising a pair of beads, a carcass extending on and between one bead and the other bead, a belt located radially outward of the carcass, and a tread located radially outward of the belt and haying a tread surface that comes into contact with a road surface, wherein
at least three circumferential grooves are formed on the tread so as to be aligned in an axial direction, whereby at least four land portions are formed therein so as to be aligned in the axial direction,
among these circumferential grooves, a circumferential groove located on each outermost side in the axial direction is a shoulder circumferential groove,
among these land portions, a land portion located on each outermost side in the axial direction is a shoulder land portion,
holes are provided in the shoulder land portion so as to extend from an outer surface of the shoulder land portion toward an inner side in a radial direction,
each hole is provided at a position at which the hole is not in contact with a normal line of an inner surface of the tire passing through an end of the tread surface,
a depth of the hole is not larger than a depth of the shoulder circumferential groove,
the hole includes an opening-side portion having at least one of a region whose width decreases toward the inner side in the radial direction or a region whose width is constant, and a hole bottom-side portion connected to the opening-side portion and provided radially inward of the opening-side portion,
the hole bottom-side portion includes an outer hole bottom-side portion whose width increases toward the inner side in the radial direction, and an inner hole bottom-side portion whose width decreases toward the inner side in the radial direction, and
a width of a boundary between the outer hole bottom-side portion and the inner hole bottom-side portion is 1.5 to 2.5 times a width of a radially inner end portion of the opening-side portion.

2. The heavy duty pneumatic tire according to claim 1, wherein
in the hole, a shape of a cross-section perpendicular to a central axis of the hole is a circle,
the width of the radially inner end portion of the opening-side portion is 2.0 to 3.5 mm,
a shape of a wall surface of the inner hole bottom-side portion is a shape composed of only a part of a spherical surface, and
a radius R of the spherical surface is not less than 2.0 mm.

3. The heavy duty pneumatic tire according to claim 1, wherein
in the hole, a shape of a cross-section perpendicular to a central axis of the hole is a circle,
the width of the radially inner end portion of the opening-side portion is 2.0 to 3.5 mm, and
a shape of a wall surface of the inner hole bottom-side portion is a shape composed of a combination of a curved surface and a flat surface.

4. The heavy duty pneumatic tire according to claim 1, wherein a distance from a bottom to the boundary between the outer hole bottom-side portion and the inner hole bottom-side portion in the hole bottom-side portion is 25 to 50% of the width of the boundary between the outer hole bottom-side portion and the inner hole bottom-side portion.

5. The heavy duty pneumatic tire according to claim 1, wherein the depth of the hole is 90 to 100% of the depth of the shoulder circumferential groove.

6. The heavy duty pneumatic tire according to claim 1, wherein a midpoint between the end of the tread surface and the tire inner surface on a normal line of the tire inner surface passing through the end of the tread surface is defined as a point PM, and a normal line of the tread surface passing through the point PM intersects the hole.

7. The heavy duty pneumatic tire according to claim 1, wherein
the shoulder land portion includes a plurality of shoulder blocks demarcated by a plurality of axial grooves aligned in the axial direction,
an opening of the hole is located in a region where a distance from one end side in a circumferential direction in a tread surface of the shoulder block is 30 to 70% of a length in the circumferential direction of the shoulder block, and
a maximum number of the holes provided in each shoulder block is three.

8. The heavy duty pneumatic tire according to claim 1, wherein an opening width of the hole is larger than the width of the radially inner end portion of the opening-side portion.

9. The heavy duty pneumatic tire according to claim 1, wherein a cross-sectional shape of at least a portion, of the outer hole bottom-side portion, connected to the opening-side portion is a shape having curved lines between which a width increases toward the inner side in the radial direction.

10. The heavy duty pneumatic tire according to claim 2, wherein a distance from a bottom to the boundary between the outer hole bottom-side portion and the inner hole bottom-side portion in the hole bottom-side portion is 25 to 50% of the width of the boundary between the outer hole bottom-side portion and the inner hole bottom-side portion.

11. The heavy duty pneumatic tire according to claim 2, wherein the depth of the hole is 90 to 100% of the depth of the shoulder circumferential groove.

12. The heavy duty pneumatic tire according to claim 2, wherein the depth of the hole is 12 to 25 mm.

13. The heavy duty pneumatic tire according to claim 2, wherein a height of the hole bottom-side portion is 6 to 12 mm.

14. The heavy duty pneumatic tire according to claim 2, herein a interval between the holes provided in the circumferential direction is 20 to 80 mm.

15. The heavy duty pneumatic tire according to claim 3, wherein a distance from a bottom to the boundary between the outer hole bottom-side portion and the inner hole bottom-side portion in the hole bottom-side portion is 25 to 50% of the width of the boundary between the outer hole bottom-side portion and the inner hole bottom-side portion.

16. The heavy duty pneumatic tire according to claim 3, wherein the depth of the hole is 90 to 100% of the depth of the shoulder circumferential groove.

17. The heavy duty pneumatic tire according to claim 3, wherein the depth of the hole is 12 to 25 mm.

18. The heavy duty pneumatic tire according to claim 3, wherein a height of the hole bottom-side portion is 6 to 12 mm.

19. The heavy duty pneumatic tire according to claim 3, wherein a interval between the holes provided in the circumferential direction is 20 to 80 mm.
